(19) United States
(12) Patent Application Publication
(10) Pub. No.: US 2016/0079896 A1
(43) Pub. Date: Mar. 17, 2016

(54) CONTROL DEVICE OF STEPPING MOTOR, ELECTRONIC APPARATUS, RECORDING APPARATUS, ROBOT, CONTROL METHOD OF STEPPING MOTOR, AND CONTROL PROGRAM OF STEPPING MOTOR

(71) Applicant: SEIKO EPSON CORPORATION, Tokyo (JP)

(72) Inventor: Akitoshi MAEDA, Shiojiri-shi (JP)

(21) Appl. No.: 14/850,892

(22) Filed: Sep. 10, 2015

(30) Foreign Application Priority Data
Sep. 12, 2014 (JP) 2014-186529
Jun. 11, 2015 (JP) 2015-118262

(51) Int. Cl. H02P 8/00

(52) U.S. Cl. CPC H02P 8/00

(57) ABSTRACT

A control device includes a position generating section that generates a position signal including position information of a rotor, an electrical angle detection section that outputs a detection electrical angle signal including electrical angle information that is obtained by multiplying a coefficient by the position signal, and a driving section that outputs an excitation current to a coil based on an amplitude signal including amplitude information of the excitation current and the detection electrical angle signal.

### BACKGROUND

1. Technical Field

The present invention relates to a control device of a stepping motor, an electronic apparatus, a recording apparatus, a robot, a control method of the stepping motor, and a control program of the stepping motor.

2. Related Art

A stepping motor is a synchronous motor that rotates a rotor by a magnetic flux which is generated by supplying an excitation current to each of coils of a plurality of phases provided on a stator. Positioning control in which the rotational angle of the rotor is determined according to the number of an input pulse is easily performed in the stepping motor and the stepping motor is often driven by an open-loop control.

However, when driving at high speed or driving with a heavy load, deviation occurs between a target position and an actual position of the rotor, and then stepping out may occur.

Thus, in the stepping motor, in order to prevent stepping out, a feedback control may be executed based on a position of the rotor. A technique is disclosed in JP-A-2014-96922, in which a feedback control is executed by detecting the position of the rotor using an encoder.

However, in the control device of the related art, detection resolution of the encoder is set to be N times (N is a natural number of 2 or more) of a frequency of an electrical angle per one revolution of the rotor and the electrical angle of the rotor is detected based on a remainder that is obtained by dividing the position of the rotor detected by the encoder by N. Thus, it is necessary to execute remainder calculation and there is a problem that the detection resolution of the encoder receives restrictions of the cycle number of the electrical angle per one revolution of the rotor.

### SUMMARY

An advantage of some aspects of the invention is to calculate an electrical angle of a rotor with simple calculation and to alleviate restrictions of the resolution of an encoder.

A control device of a stepping motor according to an aspect of the invention allows a rotor to be rotated by a magnetic flux generated by supplying an excitation current to a coil corresponding to each of a plurality of phases. The control device includes: a position generating section that generates a position signal including position information of the rotor that is detected; an electrical angle detection section that outputs a detection signal of the electrical angle including electrical angle information that is obtained by multiplying a coefficient by the position signal; and a driving section that outputs the excitation current to the coil based on an amplitude signal including amplitude information of the excitation current and the detection signal of the electrical angle.

According to the aspect, since the detection signal of the electrical angle is generated by multiplying the coefficient by the position signal, it is possible to eliminate a need to calculate a remainder by a remainder calculation and to reduce a calculation load. Furthermore, since restrictions of the resolution of the position generating section are eliminated, it is possible to expand a degree of freedom.

In the control device of a stepping motor according to the aspect, it is preferable that the driving section includes a speed detection section that outputs a detection signal of a speed including speed information of the rotor based on the position signal, an advance angle generating section that generates an advance angle signal including advance angle information based on the detection signal of the speed, and a command section that generates a command signal of the electrical angle including electrical angle information of the excitation current based on the advance angle signal and the detection signal of the electrical angle. The driving section preferably outputs the excitation current based on the amplitude signal and the command signal of the electrical angle.

According to the aspect with this configuration, since the command signal of the electrical angle is generated based on the advance angle signal and the detection signal of the electrical angle, it is possible to efficiently generate a torque depending on the detection speed. Furthermore, since restrictions of the resolution of the position generating section are eliminated, it is possible to improve the precision of the advance angle and to improve control performance of the stepping motor by using the position generating section of high resolution.

It is preferable that the control device of a stepping motor according to the aspect further includes: a processing section that calculates a deviation between a signal indicating a target value that is a target position of the rotor and the position signal as an error signal of a position, generates a command signal of the speed including speed information of the rotor based on the error signal of the position, calculates a deviation between the command signal of the speed and the detection signal of the speed as an error signal of the speed, and generates the amplitude signal based on the error signal of the speed. According to the aspect, since function as the speed detection section for generating the advance angle and function as the speed detection section for performing feedback control of the speed detection can be executed therein, it is possible to simplify the configuration.

In the control device of a stepping motor according to the aspect with this configuration, preferably, the position generating section has resolution of 18 bits or more. According to the aspect, it is possible to improve the performance of feedback control. As a result, it is possible to use an inexpensive stepping motor having a simple structure in various apparatuses compared to a coreless motor that is a mainstream of an industrial galvanomotor.

In the control device of a stepping motor according to the aspect, it is preferable that, when the coefficient is K, the cycle number of the electrical angle per one revolution of the rotor is α, control resolution of the electrical angle is β, and resolution of the position generating section is γ, the coefficient K is given by the following Equation.

K=(α×β/γ)×(β−1)

In this case, since the cycle number α, the control resolution β of the electrical angle, and the resolution γ of the position generating section are fixed, the coefficient K is also fixed and the calculation is simplified.

An electronic apparatus according to another aspect of the invention includes: the control device of a stepping motor described above; and a stepping motor. Such an electronic apparatus includes a laser scanner apparatus, an NC processing machine, a 3-D printer, and the like.

A recording apparatus according to still another aspect of the invention includes: the control device of a stepping motor described above; and a stepping motor. Such a recording apparatus (image printing apparatus) includes a printer, a label printing apparatus, and the like.

A robot according to yet another aspect of the invention includes: the control device of a stepping motor describe above; and a stepping motor. Such a robot includes a vertical articulated robot, a dual-arm robot, other multi-axis robots, and the like.

The control device of the stepping motor described above can be grasped as a control method of the stepping motor. The control method is a control method of a stepping motor for controlling a stepping motor which allows a rotor to be rotated by a magnetic flux generated by supplying an excitation current to a coil corresponding to each of a plurality of phases, and the control method includes: acquiring a position signal indicating a position of the rotor; generating a detection signal of an electrical angle including information of the electrical angle obtained by multiplying a coefficient by the position signal; and outputting the excitation current based on an amplitude signal indicating amplitude of a current and the detection signal of the electrical angle.

The control device of the stepping motor described above can be grasped as a control program of the stepping motor. The control program is provided for controlling a stepping motor which allows a rotor to be rotated by a magnetic flux generated by supplying an excitation current to a coil corresponding to each of a plurality of phases, and the control program includes generating a detection signal of an electrical angle including information of the electrical angle obtained by multiplying a coefficient by a position signal indicating a position of the rotor; and generating a command signal of the electrical angle indicating the electrical angle of an excitation current based on an amplitude signal indicating an amplitude of a current and a detection signal of the electrical angle.

### BRIEF DESCRIPTION OF THE DRAWINGS

The invention will be described with reference to the accompanying drawings, wherein like numbers reference like elements.

FIG. 1 is a diagram illustrating a configuration example of a control device of a stepping motor according to an embodiment of the invention.

FIG. 2 is an explanatory diagram illustrating an A-phase current command signal and a B-phase current command signal.

FIG. 3 is a view illustrating a configuration example of a laser scanner apparatus to which the control device of the stepping motor according to the embodiment of the invention is applied.

FIG. 4 is an external perspective view of a vertical articulated (6 axes) robot to which the control device of the stepping motor according to the embodiment of the invention is applied.

FIG. 5 is a front view schematically illustrating a first configuration example (image recording apparatus) of a recording apparatus to which the control device of the stepping motor according to the embodiment of the invention is applied.

FIG. 6 is a front view schematically illustrating a second configuration example (printer) of a recording apparatus to which the control device of the stepping motor according to the embodiment of the invention is applied.

### DESCRIPTION OF EXEMPLARY EMBODIMENTS

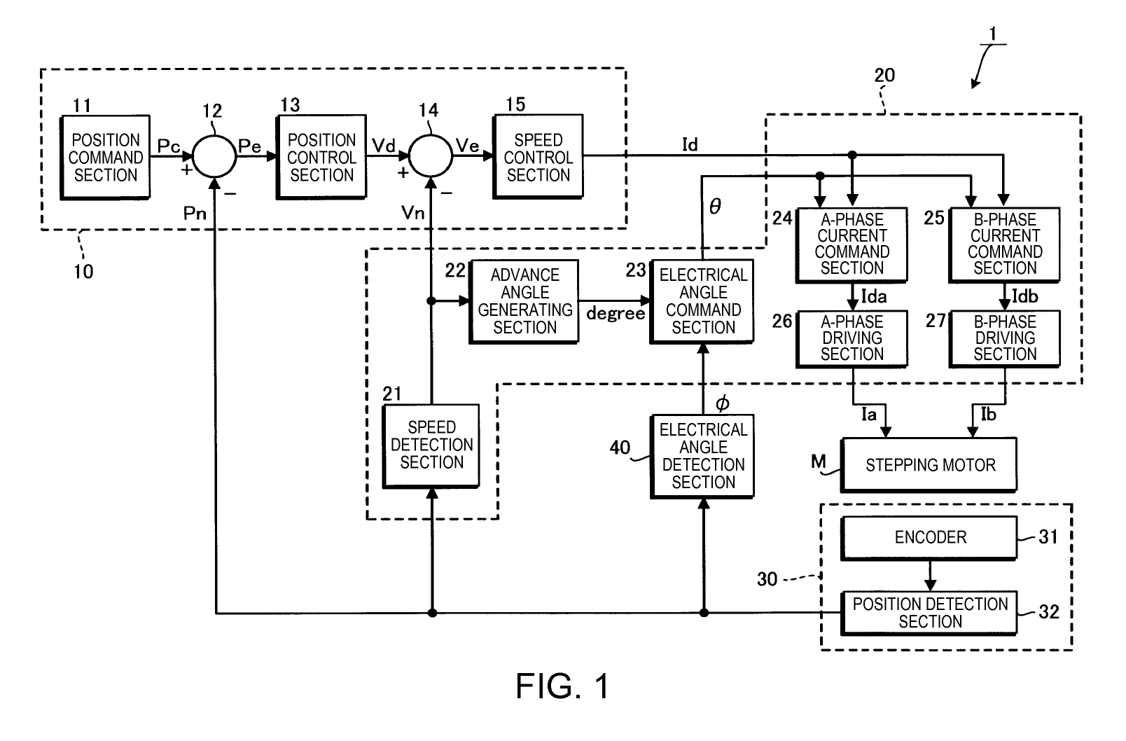

Hereinafter, a control device (hereinafter, simply referred to as “control device”) and a control method of a stepping motor according to an embodiment of the invention will be described. FIG. 1 is a diagram illustrating a configuration example of the control device according to the embodiment.

As illustrated in FIG. 1, a control device 1 according to the embodiment is a device for controlling drive of a stepping motor M. Moreover, a stepping motor unit is configured by integrally forming the control device 1 and the stepping motor M illustrated in FIG. 1.

The stepping motor M includes an A-phase stator coil (hereinafter, simply referred to as “A-phase coil”), a B-phase stator coil (hereinafter, simply referred to as “B-phase coil”), and a rotor on which a rotary shaft is mounted.

The stepping motor M is a so-called brushless motor. That is, a magnetic force is generated by supplying a predetermined excitation current to the A-phase coil and the B-phase coil, and, for example, the rotor is rotated by the magnetic force.

Specifically, in the stepping motor M, an excitation phase is switched and the rotor is rotated by switching the coil through which the excitation current flows.

Moreover, in the embodiment, a two-phase type stepping motor M configured to have an A-phase and a B-phase is used, but the configuration of the stepping motor M is not limited to the embodiment. For example, the number of phases of the stepping motor M is not limited to 2 phases and the stepping motor M may have a single phase, 3 phases, 4 phases, 5 phases, and the like. Furthermore, also the type of the rotor is not specifically limited and a Permanent Magnet (PM) type, a Variable Reluctance (VR) type, a Hybrid (HB) type, and the like can be used.

The control device 1 includes a processing section 10, a driving section 20, a position generating section 30, and an electrical angle detection section 40. The position generating section 30 outputs a detection position signal (position signal) Pn including practical position information of the rotor. Thus, specifically, the detection position signal Pn indicates an angle of the rotor as position information. The position generating section 30 of this example includes an encoder 31 and a position detection section 32. For example, it is preferable that the encoder 31 has resolution of 18 bits or more per one revolution. In a case of the resolution of 18 bits, the encoder 31 outputs pulses of 2¹⁸−1 per one revolution. The position detection section 32 counts the pulses output from the encoder 31 and generates the detection position signal Pn. The detection position signal Pn circulates values of 0 to 2¹⁸−1 such as 0, 1, 2, . . . 2¹⁸−1, 0, 1, . . . . The resolution of the position detection section 32 is determined by the encoder 31. In this example, the encoder 31 and the position detection section 32 are separated, but of course, an encoder in which the position detection section is mounted on an inside thereof may be used.

Next, the processing section 10 includes a position command section 11, subtractors 12 and 14, a position control section 13, and a speed control section 15, and generates a current amplitude command signal (amplitude signal) Id indicating information (amplitude information) of an amplitude of the excitation current.

The position command section 11 outputs a signal indicating a target value of the position of the rotor as a position command signal Pc. The position command signal Pc indicates an angle of the rotor to be the target. The position command signal Pc is input from the position command section 11 into the subtractor 12 and the detection position signal Pn is fed back to the subtractor 12. The subtractor 12 calculates a deviation (in other words, value obtained by subtracting a detection position from the target value of the rotational angle of the rotor) between the position command signal Pc and the detection position signal Pn, and outputs a position error signal Pe indicating a calculation result.

The position control section 13 calculates a target value of an angular speed of the stepping motor M depending on the position error signal Pe by executing a predetermined calculating process on the position error signal Pe using a proportional gain and the like, and outputs a signal indicating the target value as a speed command signal (command signal of the speed) Vd.

The speed command signal Vd is input from the position control section 13 into the subtractor 14 and a detection speed signal Vn indicating the current angular speed of the rotor is fed back to the subtractor 14. The subtractor 14 calculates a deviation (in other words, a value that is obtained by subtracting the detection speed signal Vn from the target value of the angular speed of the rotor) between the speed command signal Vd and the detection speed signal Vn, and outputs the deviation as a speed error signal Ve (error signal of the speed). The speed control section 15 performs a predetermined calculating process including integration using the speed error signal Ve input from the subtractor 14, the proportional gain of the angular speed that is a predetermined coefficient, the integral gain of the angular speed, and the like, and then generates a signal indicating the amplitude of the excitation current, and outputs the signal as the current amplitude command signal Id.

Next, the driving section 20 includes a speed detection section 21, an advance angle generating section 22, and an electrical angle command section (command section) 23. The speed detection section 21 outputs the detection speed signal (detection signal of the speed) Vn indicating a current angular speed (speed information) of the rotor based on the detection position signal Pn indicating the current angle of rotor to the subtractor 14 and the advance angle generating section 22. Moreover, since function as the speed detection section for generating the advance angle and function as the speed detection section for feedback controlling the detection speed can be executed therein, the configuration is simplified.

The advance angle generating section 22 generates an advance angle signal (advance angle signal including information of the advance angle) degree indicating the advance angle depending on the detection speed signal Vn. If the angular speed of the rotor is increased, since the rotor advances early during a time from when the current flows through the coil to a time when torque is generated, the time during which torque can be generated becomes short. Thus, it is possible to generate a large torque by accelerating timing for supplying the current to the coil depending on the current angular speed of the rotor. The advance angle is specified by the viewpoint of the above description. More specifically, the advance angle generating section 22 includes a table with the detection speed and the advance angle corresponding with each other, and may generate the advance angle by referring to the table using the detection speed signal Vn.

The electrical angle command section 23 generates an electrical angle command signal θ based on a detection electrical angle signal (detection signal of the electrical angle) φ including information of the current electrical angle and the advance angle signal degree. The detection electrical angle signal φ is generated by multiplying a coefficient K by the detection position signal Pn in the electrical angle detection section 40. Here, when the cycle number of the electrical angle per one revolution of the rotor is α, control resolution of the electrical angle is β, and detection resolution of the encoder is γ, the coefficient K is given by Equation 1 and the detection electrical angle signal (electrical angle) φ is given by Equation 2.

K=(α×β/γ)×(β−1) Equation 1

φ=K×Pn Equation 2

For example, the cycle number α of the electrical angle per one revolution of the rotor is 50 cycles, the control resolution β of the electrical angle is 2⁸ (8 bits), the detection resolution of the encoder is 2²⁰ (20 bits), and the detection position indicating the detection position signal Pn is 3000. In this case, the detection electrical angle signal φ is calculated by Equation 3.

φ=3000×(50×2/2²⁰)×(2⁸−1) Equation 3

In the control device of the related art, the detection resolution γ of the encoder is set to be a natural number multiple N of the cycle number α and the detection electrical angle signal φ is calculated based on the remainder R that is obtained by dividing the detection position indicating the detection position signal Pn by N. In this method, it is necessary to execute a remainder calculation and there is a disadvantage that the detection resolution γ of the encoder is restricted by the cycle number α.

On the contrary, according to the embodiment described above, the cycle number α, the control resolution β of the electrical angle, and the detection resolution γ of the encoder which are elements of the coefficient K are all known. Thus, the coefficient K can be stored by calculating in advance and it is possible to calculate the detection electrical angle signal φ only by multiplication. Furthermore, there is an advantage that the detection resolution γ of the encoder can be determined independent of the cycle number α.

Next, in a case where a position of 90 degrees of the electrical angle is excited, when a rotation direction CW is “1” if the rotor rotates in a forward direction and when a rotation direction CW is “−1” if the rotor rotates in a reverse direction, the electrical angle command section 23 calculates the electrical angle command signal θ according to the following Equation 4 and Equation 5.

When CW=1,θ=φ+degree+90 Equation 4

When CW=−1,θ=θ=φdegree−90 Equation 5

As described above, since the electrical angle command signal θ is generated based on the advance angle signal degree and the detection electrical angle signal β, it is possible to efficiently generate the torque depending on the detection speed signal Vn. Furthermore, since there are no restrictions in the resolution of the position generating section 30, it is possible to improve the precision of the advance angle signal degree and to improve control performance of the stepping motor M by using the position generating section 30 of high resolution.

Furthermore, the driving section 20 includes an A-phase current command section 24, a B-phase current command section 25, an A-phase driving section 26, and a B-phase driving section 27.

The A-phase current command section 24 generates an A-phase current command signal Ida indicating the size of an A-phase excitation current Ia to be applied to the A-phase coil based on the current amplitude command signal Id and the electrical angle command signal θ, and the B-phase current command section 25 generates a B-phase current command signal Idb indicating the size of a B-phase excitation current Ib to be applied to the B-phase coil based on the current amplitude command signal Id and the electrical angle command signal θ.

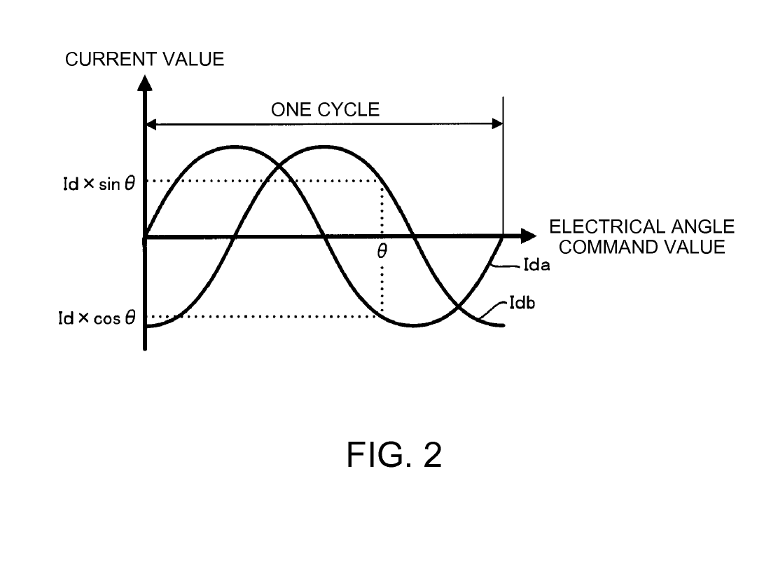

More specifically, as illustrated in FIG. 2, the A-phase current command signal Ida is given by Equation 6 and the B-phase current command signal Idb is given by Equation 7.

Ida=Id×sin θ Equation 6

Idb=Id×cos θ Equation 7

The A-phase driving section 26 illustrated in FIG. 1 generates the A-phase excitation current Ia to be the size indicated by the A-phase current command signal Ida and supplies the A-phase excitation current Ia to the A-phase coil of the stepping motor M. The B-phase driving section 27 generates the B-phase excitation current Ib to be the size indicated by the B-phase current command signal Idb and supplies the B-phase excitation current Ib to the B-phase coil of the stepping motor M. Moreover, the A-phase driving section 26 detects the size of the A-phase excitation current Ia and may perform feedback control such that the detection value is close to the A-phase current command signal Ida. The B-phase driving section 27 is also similar in this point.

As described above, according to the control device 1 of the embodiment, the encoder 31 of high resolution can be freely used independent of the cycle number α, it is possible to use an inexpensive stepping motor having a simple structure in various apparatuses compared to a coreless motor that is a mainstream of an industrial galvanomotor.

### Electronic Apparatus

### Laser Scanner Apparatus

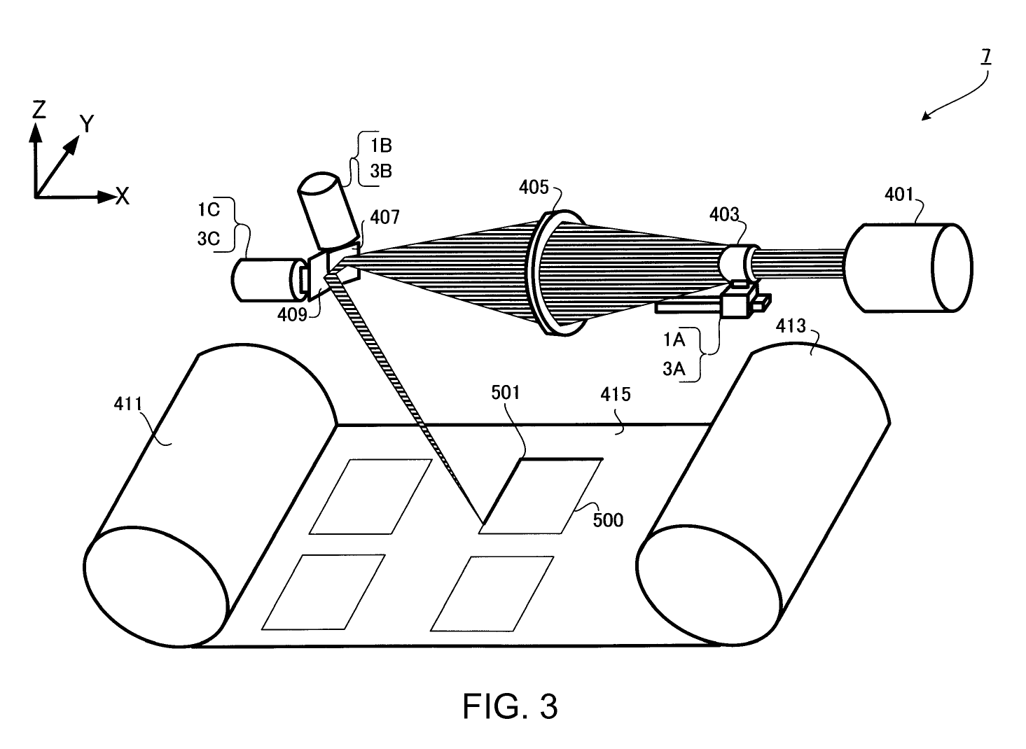

Hereinafter, a laser scanner apparatus as an example of an electronic apparatus to which the control device 1 and the stepping motor M described above are applied will be described. FIG. 3 is a view illustrating a configuration example of a laser scanner apparatus 7 to which the control device 1 of the stepping motor and the stepping motor M according to the embodiment described above are applied. The laser scanner apparatus 7 can be used for cutting printed matter such as a label. Moreover, in the description of the laser scanner apparatus 7, the stepping motor M described above is described as the stepping motors 3A, 3B, and 3C.

The laser scanner apparatus 7 as the electronic apparatus includes a laser oscillator 401, a first lens 403, a second lens 405, a first mirror 407, a second mirror 409, the stepping motor 3A, a control device 1A that performs control of the stepping motor 3A, the stepping motor 3B, a control device 1B that performs control of the stepping motor 3B, the stepping motor 3C, and a control device 1C that performs control of the stepping motor 3C.

A workpiece 415 is wound by a transport body 413 while being sent by the rotation of a transport body 411.

If the laser oscillator 401 oscillates a laser light, the laser light is incident on the first lens 403, is refracted, and is incident on the second lens 405. The second lens 405 emits the incident light so as to converge at a point on the workpiece 415. The light emitted from the second lens 405 is reflected by the first mirror 407 and the second mirror 409, and is incident on the workpiece 415.

The first lens 403 is capable of moving in a moving direction (x-axis direction) of the workpiece 415 by the transport bodies 411 and 413, and is held by a first holding member (not illustrated). Then, a driving force of the stepping motor 3A controlled by the control device 1A is transmitted to a holding member (not illustrated) by a first driving force transmitting mechanism (not illustrated), and then the first lens 403 moves.

The first mirror 407 is held by a second holding member (not illustrated) to be capable of rotating in a predetermined direction. Then, a driving force of the stepping motor 3B that is controlled by the control device 1B is transmitted to the second holding member (not illustrated) by a second driving force transmitting mechanism (not illustrated), and then the first mirror 407 rotates. An incident angle and an exit angle of the light incident on the first mirror 407 are changed by the rotation.

The second mirror 409 is held by a third holding member (not illustrated) to be capable of rotating in a predetermined direction. Then, a driving force of the stepping motor 3C that is controlled by the control device 1C is transmitted to the third holding member (not illustrated) by a third driving force transmitting mechanism (not illustrated), and then the second mirror 409 rotates. An incident angle and an exit angle of the light incident on the second mirror 409 are changed by the rotation.

Then, it is possible to apply the laser light to a desired position on the workpiece 415 by controlling each of the stepping motors 3A, 3B, and 3C by each of the control devices 1A, 1B, and 1C. Thus, as illustrated in FIG. 3, it is possible to apply the laser light on a workpiece line 500 indicating a predetermined position of laser machining. In the same view, a line to which a reference numeral 501 is added indicates a position where machining is completed by applying the laser light.

According to the laser scanner apparatus 7 described above, it is possible to inexpensively use the stepping motors 3A, 3B, and 3C, and the control devices 1A, 1B, and 1C thereof for controlling an irradiation position of the laser light while maintaining rotation precision. That is, the stepping motors 3A, 3B, and 3C, and the control devices 1A, 1B, and 1C thereof can freely use the encoder 31 (see FIG. 1) of high resolution independent of the cycle number α. It is possible to make an inexpensive stepping motor having a simple structure compared to the coreless motor that is the mainstream of an industrial galvanomotor. Thus, it is possible to provide the inexpensive laser scanner apparatus 7 while maintaining irradiation position precision of the laser light.

As described above, the laser scanner apparatus is exemplified as the electronic apparatus including the control device 1 and the stepping motor M, but an NC machine, a 3D printer, and the like are also a kind of the electronic apparatus, and similar effects described above are achieved.

### Robot

Next, a robot to which the control device 1 and the stepping motor M described above are applied will be described. Moreover, as an example of the robot, hereinafter, a vertical articulated robot (6 axes) is illustrated, but as the robot, the robot is not limited to the example and may be a dual-arm robot and other axes robot. Moreover, in the description of a robot 8, the stepping motor M described above is described as stepping motors 3E, 3F, 3G, 3H, 3I, and 3J.

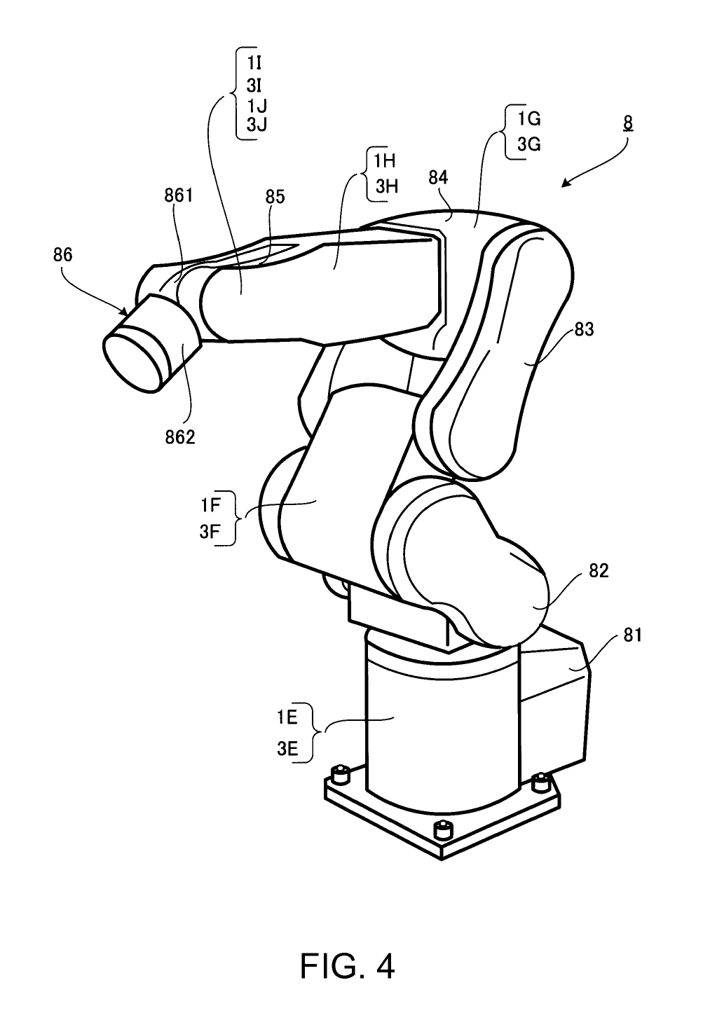

A robot 8 illustrated in FIG. 4 is the vertical articulated robot. Such a robot 8 includes a base 81, four arms 82, 83, 84, and 85, and a wrist 86, and these members are connected in order.

For example, the base 81 is fixed to a floor surface (not illustrated) by bolts and the like. The arm 82 is connected to an upper end portion of the base 81 in an inclined posture with respect to a horizontal direction and the arm 82 is capable of rotating around a rotational axis along the vertical direction with respect to the base 81. Furthermore, the stepping motor 3E that rotates the arm 82 and a control device 1E that performs control of the stepping motor 3E are disposed inside the base 81.

The arm 83 is connected to a tip end portion of the arm 82 and the arm 83 is capable of rotating around the rotational axis along the horizontal direction with respect to the arm 82. Furthermore, the stepping motor 3F that rotates the arm 83 with respect to the arm 82 and a control device 1F that performs control of the stepping motor 3F are disposed inside the arm 83.

The arm 84 is connected to a tip end portion of the arm 83 and the arm 84 is capable of rotating around the rotational axis along the horizontal direction with respect to the arm 83. Furthermore, the stepping motor 3G that rotates the arm 84 with respect to the arm 83 and a control device 1G that performs control of the stepping motor 3G are disposed inside the arm 84.

The arm 85 is connected to a tip end portion of the arm 84 and the arm 85 is capable of rotating around the rotational axis along a center shaft of the arm. 84 with respect to the arm 84. Furthermore, the stepping motor 3H that rotates the arm 85 with respect to the arm 84 and a control device 1H that performs control of the stepping motor 3H are disposed inside the arm 85.

The wrist 86 is connected to a tip end portion of the arm 85. The wrist 86 has a ring-shaped support ring 861 connected to the arm 85 and a cylindrical wrist body 862 supported by a tip end portion of the support ring 861. A tip end surface of the wrist body 862 is a flat surface and, for example, is a mounting surface on which a manipulator for gripping a precision apparatus such as a wristwatch is mounted.

The support ring 861 is capable of rotating around a rotational axis along the horizontal direction with respect to the arm 85. Furthermore, the wrist body 862 is capable of rotating around a rotational axis along a center shaft of the wrist body 862 with respect to the support ring 861. Furthermore, the stepping motor 3I that rotates the support ring 861 with respect to the arm 85, a control device 1I that performs control of the stepping motor 3I, the stepping motor 3J that rotates the wrist body 862 with respect to the support ring 861, and a control device 1J that performs control of the stepping motor 3J are disposed inside the arm 85. Driving forces of the stepping motors 3I and 3J are respectively transmitted to the support ring 861 and the wrist body 862 by a driving force transmitting mechanism (not illustrated).

According to the robot 8 described above, it is possible to use the inexpensive stepping motors 3E, 3F, 3G, 3H, 3I, and 3J, and the control devices 1E, 1F, 1G, 1H, 11, and 1J thereof for controlling rotation positions of the four arms 82, 83, 84, and 85, and the wrist 86 while maintaining rotation precision. That is, the stepping motors 3E, 3F, 3G, 3H, 3I, and 3J, and the control devices 1E, 1F, 1G, 1H, 11, and 1J thereof can use the encoder 31 (see FIG. 1) of high resolution independent of the cycle number α and can be simple in structure and inexpensive compared to the coreless motor that is the mainstream of an industrial galvanomotor. Thus, the robot 8 can be provided inexpensively while maintaining high position precision.

As described above, as the robot 8 including the control device 1 and the stepping motor M, the vertical articulated robot is exemplified, but a double-arm robot, another multi-axis robot, and the like are a kind of the robot, and similar effects described above can be achieved.

### Modification Example

As described above, the control device and the control method of the stepping motor, and the robot are described with respect to the illustrated embodiments, but the invention is not limited to the embodiments and the configuration of each section can be replaced with an arbitrary configuration having a similar function. Furthermore, another arbitrary configuration matter may be added to the invention. For example, the following modification examples may be included in the invention.

### First Modification Example

In the embodiments and application examples described above, portions of the processing section 10 and the driving section 20, excluding the A-phase driving section 26 and the B-phase driving section 27, and a part of or all of the position detection section 32 and the electrical angle detection section 40 may be realized by causing a CPU to execute a control program. In this case, the control program allows the CPU to function as each configuration element. More specifically, the control program is used for controlling the stepping motor that rotates the rotor by the magnetic flux generated by supplying the excitation current to the coil corresponding to each of the plurality of phases. The control program allows the CPU (computer) to function as the position generating section 30 generating the detection electrical angle signal φ indicating the current electrical angle by multiplying the coefficient K by the detection position signal Pn indicating the position of the rotor, and to function as the electrical angle command section 23 for generating the electrical angle command signal θ indicating the electrical angle of the excitation current to be applied to the coil corresponding to each of the plurality of phases based on the current amplitude command signal Id indicating the amplitude of the current and the detection electrical angle signal φ.

### Second Modification Example

In the embodiments and application examples described above, the driving section 20 generates the A-phase excitation current Ia and the B-phase excitation current Ib based on the current amplitude command signal Id, the detection electrical angle signal φ, and the detection position signal Pn, but the invention is not limited to the embodiments, and the driving section 20 may generate each excitation current based on the current amplitude command signal Id and the detection electrical angle signal φ. In this case, the advance angle generating section 22 is not essential. That is, the electrical angle command signal θ may be generated without considering the advance angle signal degree.

### Recording Apparatus

Hereinafter, an example of a recording apparatus including the laser scanner apparatus 7 to which the control device 1 and the stepping motor 3 described above are applied will be described. Moreover, in the following description, the same reference numerals are given to the same configurations as the laser scanner apparatus 7 described above, and the description may be simplified or omitted. Furthermore, in the following each view, in order to make each layer or each member big to be recognizable, a scale of each layer or each member is illustrated different from an actual scale.

### First Configuration Example of Recording Apparatus

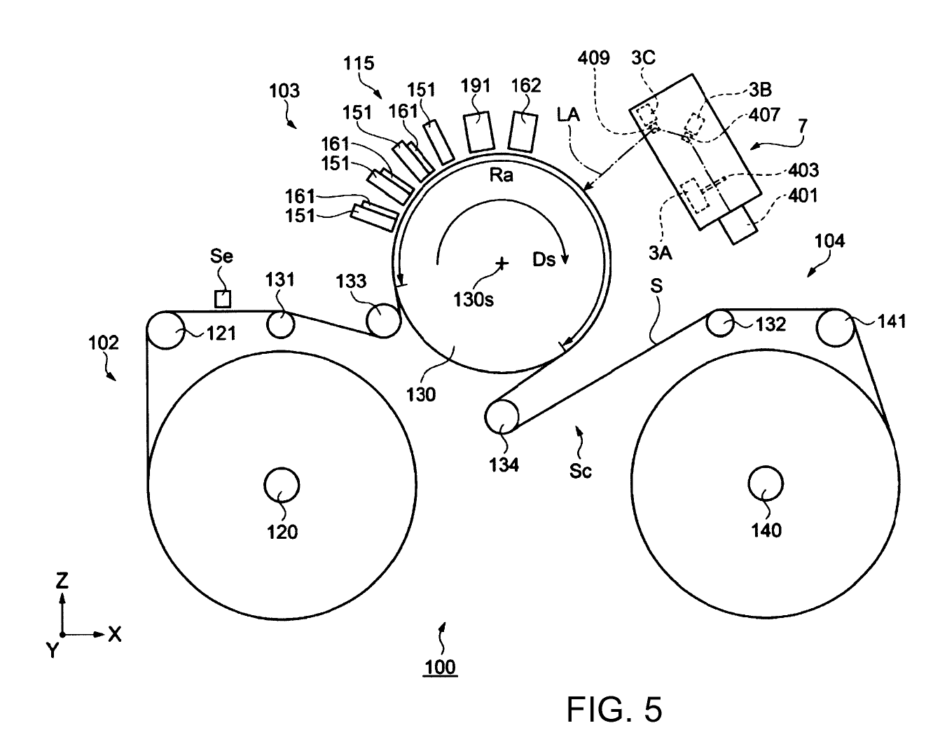

First, as a first configuration example of the recording apparatus including the laser scanner apparatus 7 to which the control device 1 and the stepping motor 3 described above are applied, an image recording apparatus 100 that is a label printing apparatus including a drum type platen will be described. FIG. 5 is a front view schematically illustrating the image recording apparatus 100 including the laser scanner apparatus 7 to which the control device 1 of the stepping motor and the stepping motor 3 according to the one embodiment described above are applied.

As illustrated in FIG. 5, in the image recording apparatus 100, one sheet S (web) as a recording medium, of which both ends are wound on a feeding shaft 120 and a winding shaft 140 in a roll shape, is stretched between the feeding shaft 120 and the winding shaft 140, and the sheet S is transported from the feeding shaft 120 to the winding shaft 140 along a transport path Sc that is stretched. Then, the image recording apparatus 100 is configured to record (form) an image on the sheet S by ejecting a functional liquid onto the sheet S transported along the transport path Sc. Moreover, the sheet S is not specifically limited. A paper-based structure, a film-base structure, or the like, or a multi-layer structure (for example, substrate of seal strip) that is formed by bonding the paper-based structure or the film-base structure in multi-layer through adhesive can be applied. For example, the paper-based structure includes a fine paper, a cast paper, an art paper, a coated paper, and the like and the film-based structure includes a synthetic paper, Polyethylene terephthalate (PET), Polypropylene (PP), and the like.

As a schematic configuration, the image recording apparatus 100 is configured to include a feeding section 102 that feeds the sheet S from the feeding shaft 120, a processing section 103 that records the image on the sheet S fed from the feeding section 102, the laser scanner apparatus 7 that cuts the sheet S on which the image is recorded by the processing section 103, and a winding section 104 that winds the sheet S on the winding shaft 140. Moreover, in the following description, a surface on which the image is recorded may be referred to as a front surface and a surface opposite thereto may be referred to as a rear surface in both surfaces of the sheet S.

The feeding section 102 has the feeding shaft 120 on which the end of the sheet S is wound and a driven roller 121 on which the sheet S drawn from the feeding shaft 120 is wound. The feeding shaft 120 winds and supports the end of the sheet S in a state where the front surface of the sheet S is directed toward the outside. Then, the feeding shaft 120 rotates in the clockwise direction of FIG. 5 and thereby the sheet S wound on the feeding shaft 120 is fed to the processing section 103 via the driven roller 121. In addition, the sheet S is wound on the feeding shaft 120 through a core tube (not illustrated) that is mounted on the feeding shaft 120 to be removable. Thus, when the sheet S of the feeding shaft 120 is used up, it is possible to replace the sheet S of the feeding shaft 120 by mounting a new core tube on which the roll-shaped sheet S is wound on the feeding shaft 120.

The processing section 103 performs an appropriate process by a recording head 151 disposed in a head unit 115 that is disposed along an outer peripheral surface of a platen drum 130 and the like while supporting the sheet S fed out from the feeding section 102 by the platen drum 130 as a support section. Then, the processing section 103 records the image on the sheet S.

The platen drum 130 is a cylindrical drum that is supported to be rotatable around a drum shaft 130s by a support mechanism (not illustrated). In addition, the platen drum 130 winds the sheet S transported from the feeding section 102 to the winding section 104 from the rear surface side thereof. The platen drum 130 supports the sheet S from the rear surface side while being driven to be rotated in a transport direction Ds of the sheet S by receiving a friction force between the platen drum 130 and the sheet S. In addition, driven rollers 133 and 134, which turn the sheet S on both sides of the winding section of the platen drum 130, are provided in the processing section 103. The driven roller 133 thereof turns the sheet S by winding the front surface of the sheet S between the driven roller 121 and the platen drum 130. Meanwhile, the driven roller 134 turns the sheet S by winding the front surface of the sheet S between the platen drum 130 and a driven roller 141. As described above, it is possible to secure a length of a winding portion Ra of the sheet S on the platen drum 130 to be long by turning the sheet S on an upstream side and a downstream side in the transport direction Ds with respect to the platen drum 130. Moreover, another driven roller 131 or an edge sensor Se that detects ends of the sheet S in a width direction may be disposed between the driven roller 121 and the driven roller 133. Furthermore, another driven roller 132 may be disposed between the driven roller 134 and the driven roller 141.

The processing section 103 includes the head unit 115 and the recording head 151 is disposed in the head unit 115. In the embodiment, a plurality of recording heads 151 corresponding to different colors from each other are provided and, for example, four recording heads 151 corresponding to yellow, cyan, magenta, and black are provided. Each recording head 151 faces the front surface of the sheet S winding on the platen drum 130 with a slight clearance (platen gap) and ejects the function liquid of corresponding color from nozzles with ink jet type. Then, each recording head 151 ejects the function liquid onto the sheet S that is transported in the transport direction Ds and thereby a color image is formed on the front surface of the sheet S.

In addition, in the embodiment, as the function liquid, ultraviolet (UV) ink (light-curable ink) that is cured by radiation of ultraviolet rays (light) is used. Therefore, a first UV light source 161 (light radiation section) is provided in the head unit 115 of the processing section 103 to fix the UV ink to the sheet S by temporarily curing the UV ink. The first UV light source 161 for temporal curing is disposed between each of a plurality of recording heads 151. That is, the first UV light source 161 cures (temporally cures) the UV ink to an extent that a shape of the UV ink does not collapse by applying weak ultraviolet rays. On the other hand, a second UV light source 162 is provided on the downstream side of the transport direction Ds with respect to the plurality of recording heads 151 (head unit 115) as a curing section for main curing. That is, the second UV light source 162 cures the UV ink completely (main curing) by applying the ultraviolet rays that is more intensive than the first UV light source 161. It is possible to fix the color image which is formed by the plurality of recording heads 151 onto the front surface of the sheet S by executing temporal curing and main curing described above.

The laser scanner apparatus 7 is provided to partially cut or divide the sheet S on which the image is recorded. Moreover, since the configuration of the laser scanner apparatus 7 is the same as the configuration described above (see FIG. 3), detailed description will be omitted.

The laser light oscillated by the laser oscillator 401 of the laser scanner apparatus 7 is applied to the sheet S that is the workpiece via the first lens 403 of which the position is controlled by the stepping motor 3A, the first mirror 407, and the second mirror 409, and the like of which the rotation positions (angles) are controlled by the stepping motors 3B and 3C. As described above, irradiation positions of laser light LA applied to the sheet S are controlled by each of the stepping motors 3A, 3B, and 3C, and the laser light LA can be applied to a desired position on the sheet S. A portion of the sheet S to which the laser light LA is applied is fused, is partially cut, or is divided.

Moreover, the portion that is cut or divided by the laser light LA may be discharged and stored in a storage section by a discharging section (not illustrated) after being fused, or may be transported to the winding shaft 140 while being held to a base material of the sheet S by adhesive.

Furthermore, in this configuration, an example, in which the sheet S is cut or divided by fusing the sheet S using the laser scanner apparatus 7 after the image is recorded, is described, but the configuration is not limited to the example, and a configuration, in which a desired position is cut or divided before the image is recorded, may be provided.

According to the image recording apparatus 100 described above, it is possible to use the stepping motors 3A, 3B, and 3C, and the control devices 1A, 1B, and 1C thereof for controlling the irradiation position of the laser light LA inexpensively while maintaining the rotation precision. That is, the stepping motors 3A, 3B, and 3C, and the control devices 1A, 1B, and 1C thereof can freely use the encoder 31 (see FIG. 1) of high resolution independent on the cycle number α and can be simple in structure and inexpensive compared to the coreless motor that is the mainstream of an industrial galvanomotor. Thus, the image recording apparatus 100 can inexpensively cut or divide the sheet S with high position precision.

### Second Configuration Example of Recording Apparatus

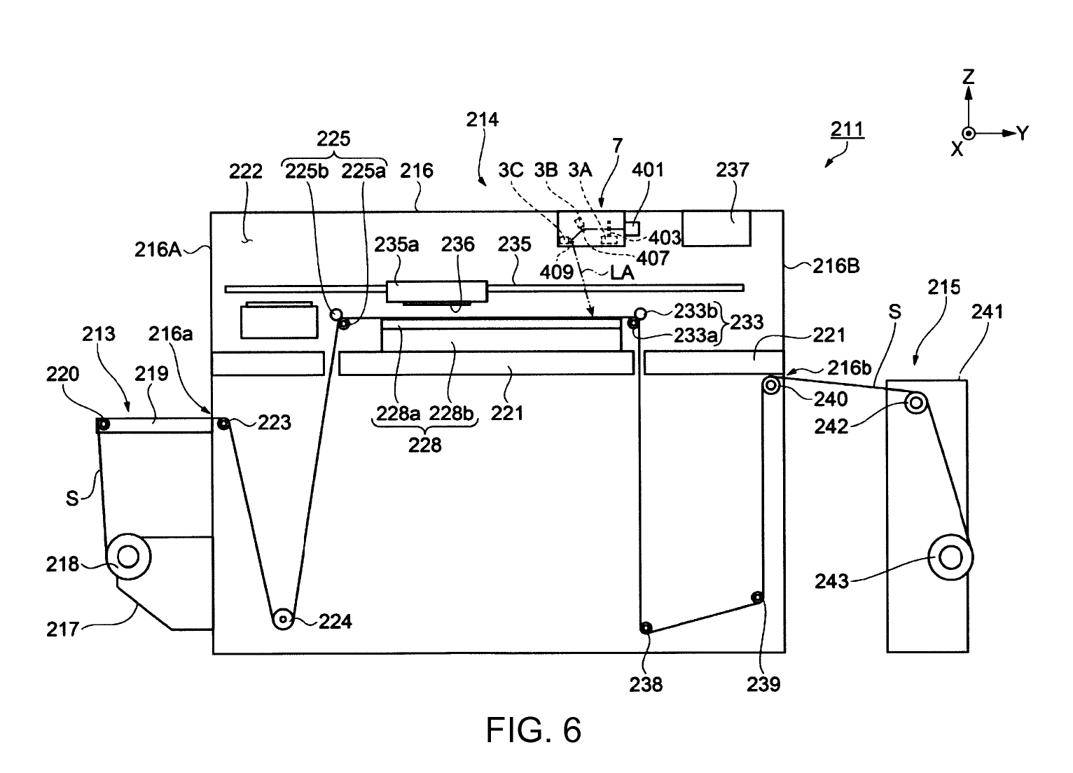

Next, as a second configuration example of the recording apparatus including the laser scanner apparatus 7 to which the control device 1 and the stepping motor 3 described above are applied, a printer (recording apparatus) 211 including a planar platen will be described. FIG. 6 is a front view schematically illustrating the printer 211 including the laser scanner apparatus 7 to which the control device 1 of the stepping motor and the stepping motor 3 according to the embodiment described above are applied.

As illustrated in FIG. 6, the printer (recording apparatus) 211 employs an ink jet type as a printing system in which a liquid is ejected onto the sheet S from a plurality of recording heads (liquid ejecting heads). In addition, the printer (recording apparatus) 211 performs printing while sequentially feeding one sheet S (web) as a recording medium wound in a roll shape and winds the sheet S again in the roll shape after printing. Since the sheet S is similar to the first configuration example described above, the description will be omitted here.

Moreover, in the embodiment, an XYZ orthogonal coordinate system is set, in which a width direction of the sheet S in a horizontal plane is an X direction, the transport direction of the sheet S orthogonal to the X direction is a Y direction, and a vertical direction is a Z direction.

The printer 211 includes a body section 214 executing a printing process, a feeding section 213 supplying the sheet S to the body section 214, and a winding section 215 winding the sheet S discharged from the body section 214.

The body section 214 includes a body case 216, the feeding section 213 is disposed on an upstream side (−Y side) of the body case 216 in the transport direction, and the winding section 215 is disposed on a downstream side (+Y side) of the body case 216 in the transport direction. The feeding section 213 is connected to a medium supply section 216a provided in a side wall 216A of the body case 216 on the upstream side (−Y side) in the transport direction. The winding section 215 is connected to a medium discharge section 216b provided in a side wall 216B on the downstream side (+Y side) in the transport direction.

The feeding section 213 includes a support plate 217 mounted on a lower portion of the side wall 216A of the body case 216, a winding shaft 218 provided on the support plate 217, a feeding stand 219 connected to the medium supply section 216a of the body case 216, and a relay roller 220 provided at a tip end of the feeding stand 219. The sheet S wound in the roll shape is supported on the winding shaft 218 to be rotatable. The sheet S fed from the roll is wound on the relay roller 220, is moved onto an upper surface of the feeding stand 219, and is transported to the medium supply section 216a along the upper surface of the feeding stand 219.

The winding section 215 includes a winding frame 241, a relay roller 242 and a winding driving shaft 243 which are provided in the winding frame 241. The sheet S discharged from the medium discharge section 216b is wound on the relay roller 242, is guided to the winding driving shaft 243, and is wound in the roll shape by driving of the winding driving shaft 243 to be rotated.

A planar base 221 is disposed horizontally inside the body case 216 of the body section 214 and the inside of the body case is divided into two spaces by the base 221. A space above the base 221 is a printing chamber 222 in which the printing process is executed on the sheet S. The printing chamber 222 is provided with a platen (medium support section) 228 fixed to the base 221, a recording head (recording processing section) 236 provided above the platen 228, a carriage 235a supporting the recording head 236, two guide shafts 235 supporting the carriage 235a, a valve unit 237, and a laser scanner apparatus 7 cutting the sheet S. The two guide shafts 235 are disposed parallel to each other along the transport direction (Y direction) and are configured such that the carriage 235a is capable of reciprocating in the transport direction.

The platen 228 has a box-shaped support stand 228a of which an upper surface is opened and a mounting plate 228b mounted on an opening of the support stand 228a. The support stand 228a is fixed to the base 221 and an inside thereof surrounded by the support stand 228a and the mounting plate 228b is a negative-pressure chamber. The sheet S is mounted on the support surface (medium support surface that is the upper surface in a +X direction in the drawing) of the mounting plate 228b.

A plurality of suction holes (not illustrated) passing through the mounting plate 228b in a thickness direction are formed in the mounting plate 228b. In one side wall (side wall on the −Y side in the embodiment) of the support stand 228a, an exhaust port (not illustrated) passing through the side wall is formed. A suction fan (not illustrated) is connected to the exhaust port. A suction force is operated on the sheet S through the plurality of suction holes by suction of the suction fan and it is possible to make the sheet S flat by absorbing the sheet S on the support surface of the mounting plate 228b.

A supply transport system including a plurality of transport rollers is provided on the upstream side (−Y side) of the platen 228 in the transport direction. The supply transport system includes a pair of first transport rollers 225 provided inside the printing chamber 222 in the vicinity of the platen 228, a relay roller 224 provided in a space of a lower side of the body case 216, and a relay roller 223 provided in the vicinity of the medium supply section 216a.

The pair of first transport rollers 225 are configured of a first driving roller 225a and a first driven roller 225b.

In the supply transport system, the sheet S introduced into the inside of the body case 216 from the feeding section 213 through the medium supply section 216a is wound from below on the first driving roller 225a via the relay rollers 223 and 224, and is nipped by the pair of first transport rollers 225. Then, the sheet S is horizontally fed on the support surface of the platen 228 from the pair of first transport rollers 225 according to rotation of the first driving roller 225a that is driven by a first transport motor (not illustrated).

On the other hand, a discharge transport system including a plurality of transport rollers is provided on the downstream side (+Y side) of the platen 228 in the transport direction. The discharge transport system includes a pair of second transport rollers 233 that is provided on a side opposite to the pair of first transport rollers 225 with respect to the platen 228, a reverse roller 238 and a relay roller 239 which are provided in the space of the lower side of the body case 216, and a delivery roller 240 that is provided in the vicinity of the medium discharge section 216b.

The pair of second transport rollers 233 are configured of a second driving roller 233a and a second driven roller 233b. Moreover, since the second driven roller 233b is disposed on the printing surface side (upper surface side) of the sheet S, the second driven roller 233b may be configured so as to abut only end edge portions of the sheet S in the width direction (X direction) to avoid damage of the printed image.

In the discharge transport system, the pair of second transport rollers 233 nipping the sheet S delivers the sheet S from above the platen 228 according to rotation of the second driving roller 233a driven by a second transport motor (not illustrated). The sheet S fed from the pair of second transport rollers 233 is transported to the delivery roller 240 via the reverse roller 238 and the relay roller 239, and is fed to the winding section 215 through the medium discharge section 216b by the delivery roller 240.

In the embodiment, the plurality of recording heads 236 are mounted on the carriage 235a through a head mounting plate (not illustrated). The head mounting plate is configured to be movable on the carriage 235a in the width direction (X direction) of the medium. A position of the head mounting plate is capable of being controlled and the head mounting plate can allow the plurality of recording heads 236 to integrally perform a line feed operation by moving the head mounting plate in the width direction (X direction) of the medium. The recording heads 236 are disposed side by side at constant intervals in the width direction of the medium on the head mounting plate such that the adjacent recording heads 236 are configured of two stages different from each other in the transport direction (Y direction) of the medium.

The plurality of recording heads 236 are respectively connected to the valve unit 237 through ink supply tubes (not illustrated). The valve unit 237 is provided on an inner wall of the body case 216 within the printing chamber 222 and is connected to an ink tank (ink storage section) (not illustrated). The valve unit 237 supplies the ink supplied from the ink tank to the recording head 236 while temporarily stores the ink.

A plurality of ink ejecting nozzles are provided on a lower surface (nozzle forming surface) of the recording head 236 in parallel in the width direction (X direction) of the medium. The recording head 236 ejects ink supplied from the valve unit 237 from the ink ejecting nozzles onto the sheet S on the platen 228 and performs printing. Moreover, the recording head 236 may have a plurality of ink ejecting nozzle columns. In this case, when performing four-color or six-color printing, if ink is allocated in each of ink ejecting nozzle columns for each color type, it is possible to eject the ink of a plurality of colors with one recording head 236.

A laser scanner apparatus 7 is included in the inside of the body case 216 of the body section 214. The laser scanner apparatus 7 is provided on the downstream side (Y side) further than the ejecting position of the ink described above. The laser scanner apparatus 7 is provided to partially cut or divide the sheet S on which the image is recorded. Moreover, since the configuration of the laser scanner apparatus 7 is similar to the configuration (see FIG. 3) described above, detailed description will be omitted.

The laser light oscillated by the laser oscillator 401 of the laser scanner apparatus 7 is applied to the sheet S that is the workpiece via the first lens 403 of which the position is controlled by the stepping motor 3A, the first mirror 407, and the second mirror 409 of which the rotation positions (angles) are controlled by the stepping motors 3B and 3C. As described above, the irradiation position of the laser light LA radiated on the sheet S is controlled by each of the stepping motors 3A, 3B, and 3C and the laser light can be applied to a desired position on the sheet S. A portion of the sheet S to which the laser light LA is applied is fused, is partially cut, or is divided.

Moreover, the portion that is cut or divided by the laser light LA may be discharged and stored in a storage section by a discharge section (not illustrated) after being fused, or may be transported to the winding section 215 while being held to a base material of the sheet S by adhesive.

Furthermore, in this configuration, an example, in which the sheet S is cut or divided by fusing the sheet S using the laser scanner apparatus 7 after the image is recorded by ejecting the ink, is described, but the configuration is not limited to the example, and a configuration, in which a desired position of the sheet S is cut or divided before the image is recorded, may be provided.

According to the printer (recording apparatus) 211 described above, the stepping motors 3A, 3B, and 3C, and the control devices 1A, 1B, and 1C (see FIG. 3) thereof for controlling the irradiation position of the laser light LA can be used inexpensively while maintaining the rotation precision. That is, the stepping motors 3A, 3B, and 3C, and the control devices 1A, 1B, and 1C thereof can freely use the encoder 31 (see FIG. 1) of high resolution independent on the cycle number α and can be simple in structure and inexpensive compared to the coreless motor that is the mainstream of an industrial galvanomotor. Thus, the printer (recording apparatus) 211 can be provided inexpensively while performing cutting or dividing of the sheet S with high position precision.

As described above, the control device and the control method of the stepping motor, the electronic apparatus, the robot, the recording apparatus, and the control program are described based on the illustrated embodiments, the configuration examples, and modification examples, but the invention is not limited to the embodiments, the configuration examples, and modification examples. The configuration of each section can be replaced with any configuration having similar function. Furthermore, other optional configurations may be added to the invention.

The entire disclosure of Japanese Patent Application No. 2014-186529, filed Sep. 12, 2014 and No. 2015-118262, filed Jun. 11, 2015 are expressly incorporated by reference herein.

What is claimed is:

1. A control device of a stepping motor which allows a rotor to be rotated by a magnetic flux generated by supplying an excitation current to a coil corresponding to each of a plurality of phases, the device comprising:
a position generating section that generates a position signal including position information of the rotor that is detected;
an electrical angle detection section that outputs a detection signal of the electrical angle including electrical angle information that is obtained by multiplying a coefficient by the position signal; and
a driving section that outputs the excitation current to the coil based on an amplitude signal including amplitude information of the excitation current and the detection signal of the electrical angle.

2. The control device of a stepping motor according to claim 1,
wherein the driving section includes
a speed detection section that outputs a detection signal of a speed including speed information of the rotor based on the position signal,
an advance angle generating section that generates an advance angle signal including advance angle information based on the detection signal of the speed, and
a command section that generates a command signal of the electrical angle including electrical angle information of the excitation current based on the advance angle signal and the detection signal of the electrical angle, and
wherein the driving section outputs the excitation current based on the amplitude signal and the command signal of the electrical angle.

3. The control device of a stepping motor according to claim 2, further comprising:
a processing section that calculates a deviation between a signal indicating a target value that is a target position of the rotor and the position signal as an error signal of a position, generates a command signal of the speed including speed information of the rotor based on the error signal of the position, calculates a deviation between the command signal of the speed and the detection signal of the speed as an error signal of the speed, and generates the amplitude signal based on the error signal of the speed.

4. The control device of a stepping motor according to claim 1,
wherein the position generating section has resolution of 18 bits or more.

5. The control device of a stepping motor according to claim 1,
wherein when the coefficient is K, the cycle number of the electrical angle per one revolution of the rotor is α, control resolution of the electrical angle is β, and resolution of the position generating section is γ,
the coefficient K is given by the following Equation:
K=(α×β/γ)×(β−1).

6. An electronic apparatus comprising:
the control device of a stepping motor according to claim 1; and
a stepping motor.

7. An electronic apparatus comprising:
the control device of a stepping motor according to claim 2; and
a stepping motor.

8. An electronic apparatus comprising:
the control device of a stepping motor according to claim 3; and
a stepping motor.

9. An electronic apparatus comprising:
the control device of a stepping motor according to claim 4; and
a stepping motor.

10. A recording apparatus comprising:
the control device of a stepping motor according to claim 1; and
a stepping motor.

11. A recording apparatus comprising:
the control device of a stepping motor according to claim 2; and
a stepping motor.

12. A recording apparatus comprising:
the control device of a stepping motor according to claim 3; and
a stepping motor.

13. A recording apparatus comprising:
the control device of a stepping motor according to claim 4; and
a stepping motor.

14. A robot comprising:
the control device of a stepping motor according to claim 1; and
a stepping motor.

15. A robot comprising:
the control device of a stepping motor according to claim 2; and
a stepping motor.

16. A robot comprising:
the control device of a stepping motor according to claim 3; and
a stepping motor.

17. A robot comprising:
the control device of a stepping motor according to claim 4; and
a stepping motor.

18. A control method of a stepping motor for controlling a stepping motor which allows a rotor to be rotated by a magnetic flux generated by supplying an excitation current to a coil corresponding to each of a plurality of phases, the method comprising:
acquiring a position signal indicating a position of the rotor;
generating a detection signal of an electrical angle including information of the electrical angle obtained by multiplying a coefficient by the position signal; and
outputting the excitation current based on an amplitude signal indicating amplitude of a current and the detection signal of the electrical angle.

19. A control program of a stepping motor comprising:
generating a detection signal of an electrical angle including information of the electrical angle obtained by multiplying a coefficient by a position signal indicating a position of a rotor; and
generating a command signal of the electrical angle indicating the electrical angle of an excitation current based on an amplitude signal indicating amplitude of a current and the detection signal of the electrical angle.
